(19) United States
(12) Patent Application Publication
(10) Pub. No.: US 2010/0012579 A1
(43) Pub. Date: Jan. 21, 2010

(54) Wastewater Separator

(76) Inventor: Wei-Hua Chiang, Hsinchu County (TW)

Correspondence Address: Dr. BANGER SHIA, 102 Lindencrest Ct., Sugar Land, TX, 77479-5201, US

(21) Appl. No.: 12/176,332

(22) Filed: Jul. 18, 2008

(51) Int. Cl. B01D 21/26

(52) U.S. Cl. 210/512.1

(57) ABSTRACT

A wastewater separator comprises an inner pivoting assembly and an outer pivoting assembly. The wastewater is guided onto a blade which helically extends in the axial direction of the inner pivoting assembly. The inner pivoting assembly and the outer pivoting assembly are driven to pivot for enabling the impurity in the wastewater to fall off along the blade and the water in the wastewater to flow upwards along the outer pivoting assembly, so as to achieve the objective of separating the water from impurity in the wastewater.

### BACKGROUND OF THE INVENTION

1. Field of the Invention

The present invention relates to a centrifugal wastewater separation, and more particularly to a wastewater separator.

2. Description of the Prior Art

A conventional wastewater separator such as a sullage concentrator disclosed in Taiwan Pat. No. 092221042 generally utilizes an inner pressure tank to discharge the sullage into a centrifugal type separator, and then enables the sullage to swirl in the centrifugal type separator. Therefore, the sullage is subjected to a centrifugal force, so that the sediment subjected to gravity greater than the centrifugal force will drop down, and the water subjected to gravity smaller than the centrifugal force will be kept in the centrifugal type separator and then guided out of the separator, thus separating the water from the sediment.

However, the above technology only utilizes the high pressure supplied from the pressure tank to produce the centrifugal force required for separation, so that when the ratio of the sediment and the water in the sullage changes, it is necessary to readjust the pressure supplied from the pressure tank to the sullage, thus increasing the operational complexity. In addition, the pressure supplied from the pressure tank can only separate the water from the sediment roughly, so that the above wastewater separator must be additionally equipped with a sieving machine to separate the water from the sediment completely, thus causing the increase of the operation procedure.

The present invention has arisen to mitigate and/or obviate the afore-described disadvantages.

### SUMMARY OF THE INVENTION

The primary objective of the present invention is to provide a wastewater separator, which can achieve the objective of separating the water from the impurities in the wastewater by utilizing an inner pivoting assembly and an outer pivoting assembly to produce a centrifugal force to enable the impurity which is relatively heavy in the wastewater to fall down along the helical blade and the water which is relatively light in the wastewater to flow upwards along the outer pivoting assembly.

In order to achieve the above objective, the wastewater separator comprises a housing, an outer pivoting assembly and an inner pivoting assembly. The housing is provided with a power source. The outer pivoting assembly is pivoted to the housing and connected to the power source. The outer pivoting assembly includes a cover cylinder. The inner pivoting assembly is pivoted in the outer pivoting assembly and connected to the power source. The inner pivoting assembly includes a helical blade which extends in an axial direction of the inner pivoting assembly and arranged opposite to the cover cylinder.

The outer pivoting assembly and the inner pivoting assembly are driven to pivot by the power source, so that when the wastewater is guided onto the blade of the inner pivoting assembly, since the blade is helical, the impurity which is relatively heavy in the wastewater will fall down along the blade, and the water which is relatively light in the wastewater will flow outwards under the action of the centrifugal force. When contacting the cover cylinder, the water flowing outwards from the blade will flow upwards along the cover cylinder, thus separating the water from the impurities in the wastewater.

### BRIEF DESCRIPTION OF THE DRAWINGS

FIG. 1 is a schematic view illustrating that a wastewater separator in accordance with the present invention is disposed on a machine;

FIG. 2 is a schematic view illustrating that a power source for a wastewater separator in accordance with the present invention consists of two motors;

FIG. 3 is a schematic view illustrating that the power source for a wastewater separator in accordance with the present invention consists of a motor; and

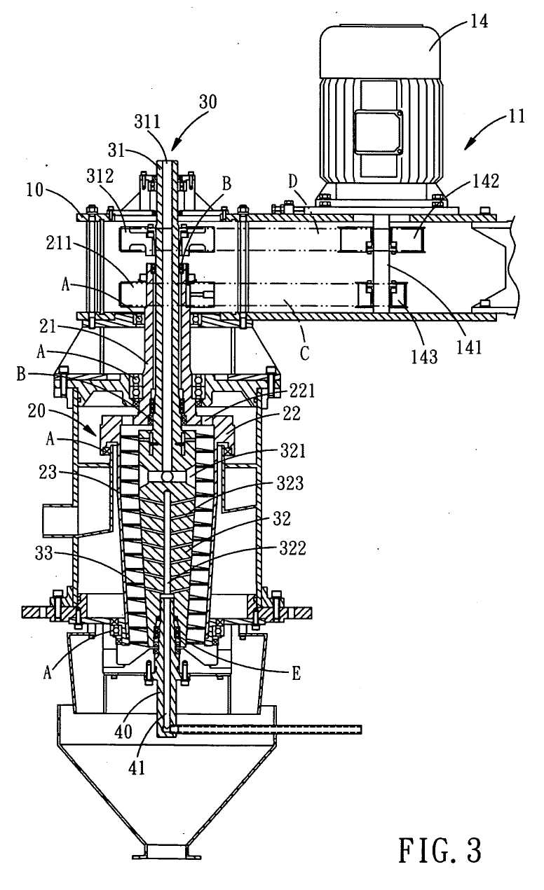

FIG. 4 is a schematic view illustrating that the power source for a wastewater separator in accordance with the present invention includes a gear box;

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

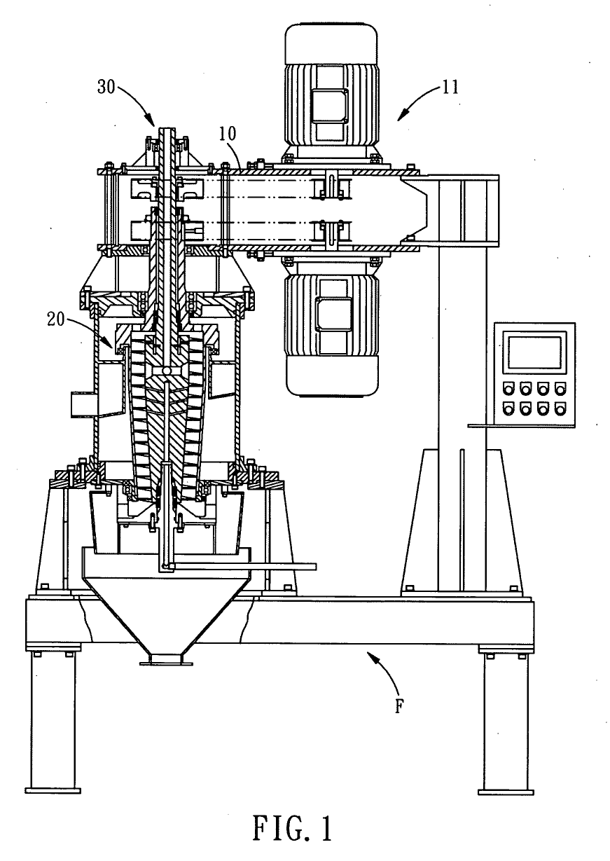

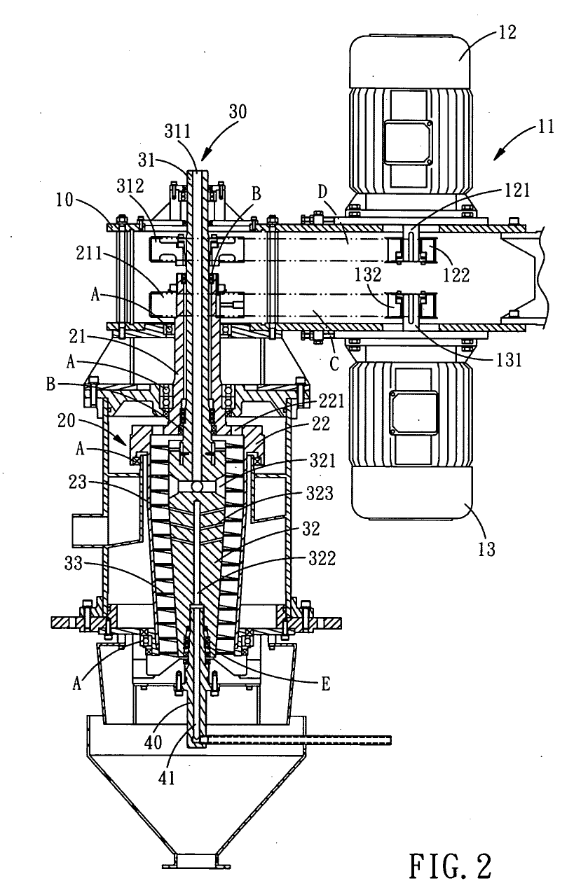

Referring to FIGS. 1-2, a wastewater separator in accordance with the present invention comprises a housing 10, an outer pivoting assembly 20, an inner pivoting assembly 30, and a water supplier 40.

The housing 10, as shown in FIG. 1, is disposed on a machine F and provided with a power source 11 consisting of a first motor 12 and a second motor 13. The shaft 121 of the first motor 12 is fixed with a first active member 122, and the shaft 131 of the second motor 13 is fixed with a second active member 132.

The outer pivoting assembly 20 is exteriorly provided with plural outer bearings A and interiorly provided with plural inner bearings B. The outer bearings A are further disposed in the housing 10 to pivot the outer pivoting assembly 20 in the housing 10 and make the outer pivoting assembly 20 pivot in a direction vertical to the ground. The outer pivoting assembly 20 includes a sleeve 21, a connection case 22 and a cover cylinder 23. The sleeve 21, the connecting case 22 are successively integrally connected with one another in such a manner both axial ends of the outer pivoting assembly 20 communicate outwards. A first passive member 211 is disposed outside the sleeve 21 and connected to the second active member 132 of the second motor 13 of the power source 11 through a first drive member C. The connecting case 22 is formed with an axial through hole 221. The cover cylinder 23 is vertically tapered downwards.

The inner pivoting assembly 30 is disposed in the inner bearings B of the outer pivoting assembly 20 in such a manner that the inner pivoting assembly 30 is pivoted in the outer pivoting assembly 20 and pivots in a direction vertical to the ground. The inner pivoting assembly 30 includes a duct 31, a blade socket 32 and a blade 33. The duct 31 includes a guiding hole 311 and is exteriorly provided with a second passive member 312, which is connected to the first active member 122 of the first motor 12 of the power source 11 through a second drive member D. The blade socket 32 is radially formed with plural flow passages 321 communicating with one another at an upper end thereof. The upper end of the blade socket 32 is integrally connected with the duct 31, and the flow passages 321 of the blade socket 32 communicate with the guiding hole 311 of the duct 31. The blade socket 32 further includes a water passage 322 and plural water outlet passages 323. The water passage 322 is axially formed under the blade socket 32. One end of the respective water outlet passages 323 communicates with the water passage 322, and the other end of the respective water outlet passages 323 communicates outwards from the side surface of the blade socket 32. The blade 33 is disposed on the side surface of the blade socket 32. The blade 33 helically extends in an axial direction of the inner pivoting assembly 30 and is arranged opposite to the cover cylinder 23 of the outer pivoting assembly 20. Between blade 33 and the cover cylinder 23 is provided a clearance.

The water supplier 40 is exteriorly provided with plural bearings E at one end thereof. The bearings E are further disposed in the water passage 322 of the blade socket 32 of the inner pivoting assembly 30 in such a manner that the end of the supplier 40 is pivoted in the water passage 322 of the blade socket 32 from the lower end of the blade socket 32. The water supplier 40 further includes a through hole 41 communicating with the water passage 322.

The shaft 121 of the first motor 12 of the power source 11 utilizes the first active member 122, the second drive member D and the second passive member 312 of the duct 31 of the inner pivoting assembly 30 to drive the inner pivoting assembly 30 to pivot. The shaft 131 of the second motor 13 of the power source 11 utilizes the second active member 132, the first drive member C and the first passive member 211 of the sleeve 21 of the outer pivoting assembly 20 to drive the outer pivoting assembly 20 to pivot.

When being guided in from the guiding hole 311 of the duct 31 of the inner pivoting assembly 30, under the action of the centrifugal force produced by the pivoting of the inner pivoting assembly 30, the wastewater will flow out to the blade 33 from the flow passage 321 of the blade socket 32. As the inner pivoting assembly 30 pivots and the wastewater is continuously guided in, the relatively heavy impurities in the wastewater will continuously increase and be pressed to drop down along the blade 33, and the relatively light water will flow outwards under the action of the centrifugal force produced by the pivoting of the inner pivoting assembly 30. When contacting the cover cylinder 13, the water flowing from the blade 33 will be guided by the tapered cover cylinder 23 in the clearance between the blade 33 and the cover cylinder 23 to flow upwards along the cover cylinder 23 and then spew upwards from the through hole 221 of the connecting case 22 of the outer pivoting assembly 20. By such arrangements, the water can be separated from the impurities.

If the power source 11 drives the outer pivoting assembly 20 and the inner pivoting assembly 30 to pivot in the same direction, the separation effect of the impurities and water in the wastewater can be improved. In addition, increasing the pivoting speed higher than the outer pivoting assembly 20 can further improve the separation effect and make the purity of separated water reach 90% and the dryness of the separated impurities reach 60%.

When the clean water is guided in through the through hole 41 of the water supplier 40, the clean water will flow in the water passage 322 of the blade socket 32 of the inner pivoting assembly 30 and then flow out of the water outlet passages 323 onto the blade 33, so that the blade 33 of the inner pivoting assembly 30 and the cover cylinder 22 of the outer pivoting assembly 20. In addition, the clean water which is guided in through the through hole 41 of the water supplier 40 during the separation of wastewater can wash the impurities separated from the wastewater.

Additionally, besides consisting of a first motor 12 and a second motor 13 to drive the inner pivoting assembly 30 and the outer pivoting assembly 20, the power source 11 can consist of a motor 14 whose shaft 141 is fixed with a third active member 142 and a fourth active member 143 to drive the inner pivoting assembly 30 and the outer pivoting assembly 20.The third active member 142 is connected to the second passive member 312 of the duct 31 of the inner pivoting assembly 30 through the second drive member D, and the fourth active member 143 is connected to the first passive member 211 of the sleeve 21 of the outer pivoting assembly 20 through the first drive member C.

In the above embodiments, the active members 122, 132, 142, 143 and the passive members 211, 312 can be in the form of a pulley, gear, dentate disc or other pivoting actuating elements. The drive members C and D can be in the form of a belt, chain or other linkage elements. The cover cylinder 23 of the outer pivoting assembly 20 can also be a straight cylinder, which has the function of separating the impurities from water in the wastewater.

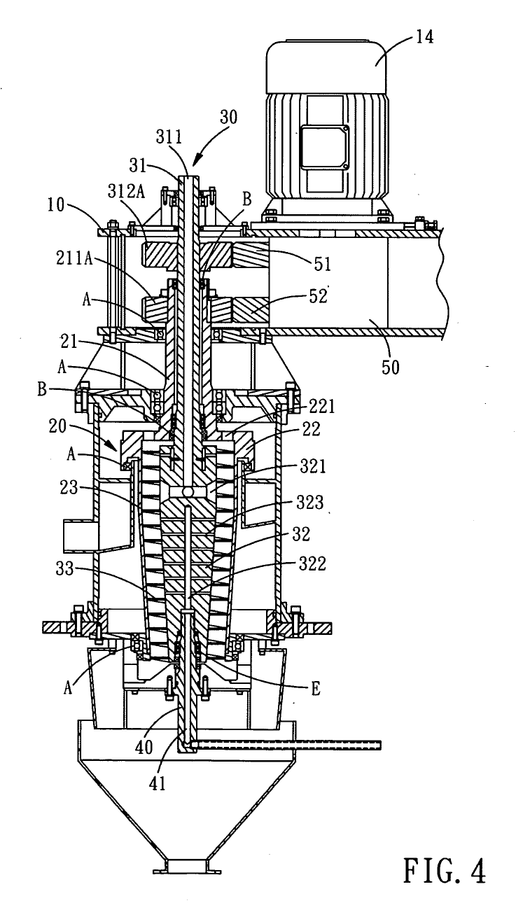

Further referring to FIG. 4, the power source 11 can also consist of a motor 14 and a gear box 50. The motor 14 is connected to the gear cluster in the gear box 50, and a first gear 51 and a second gear 52 are exposed out of the gear box 50. The first passive member 211 and the second passive member 312 are both in the form of a gear. The first passive member 211 is engaged with the second gear 52, and the second passive member 312 is engaged with the first gear 51. By such arrangements, the motor 14 of the power source 11 can utilize the first gear 51 and the second gear 52 to drive the second passive member 312 and the first passive member 211 to enable the outer pivoting assembly 20 and the inner pivoting assembly 30 to pivot, so as to separate the water from the impurities in the wastewater.

While we have shown and described various embodiments in accordance with the present invention, it is clear to those skilled in the art that further embodiments may be made without departing from the scope of the present invention.

What is claimed is:

1. A wastewater separator comprising:
a housing being provided with a power source;
an outer pivoting assembly being pivoted to the housing and connected to the power source, the outer pivoting assembly being driven to pivot about an axis vertical to a ground by the power source, the outer pivoting assembly including a cover cylinder; and
an inner pivoting assembly being pivoted in the outer pivoting assembly and connected to the power source, the inner pivoting assembly being driven to pivot about an axis vertical to the ground by the power source, the inner pivoting assembly including a blade which helically extends in an axial direction of the pivoting assembly and is arranged opposite to the cover cylinder, the outer pivoting assembly and the inner pivoting assembly being both driven by the power source to pivot for enabling an impurity which is relatively heavy in the wastewater to fall down along the blade and a water which is relatively light in the wastewater to flow upwards along the cover cylinder, so as to separate the impurities from the water in the wastewater.

2. The wastewater separator as claimed in claim 1, wherein the outer pivoting assembly further includes a sleeve, a connecting case and a cover cylinder that are integrally connected to one another, the sleeve is exteriorly provided with a first passive member connected to the power source, the connecting case is axially formed with a through hole from which the water flows out.

3. The wastewater separator as claimed in claim 2, wherein the cover cylinder of the outer pivoting assembly is vertically tapered downwards or in the form of a straight member.

4. The wastewater separator as claimed in claim 1, wherein the inner pivoting assembly further includes a duct, a blade socket and a blade, the duct includes a guiding hole and is exteriorly provided with a second passive member connected to the power source, the blade socket is radially formed at an upper end thereof with plural flow passages communicating with one another, an upper end of the blade socket is integrally connected with the duct, the flow passages of the blade socket communicate with the guiding hole of the duct, the blade is disposed on a side surface of the blade socket.

5. The wastewater separator as claimed in claim 4, wherein the blade socket of the inner pivoting assembly includes a water passage and plural water outlet passages, the water passage is axially formed under the blade socket, one end of the respective water outlet passages communicates with the water passage, and the other end of the respective water outlet passages communicates outwards from the side surface of the blade socket, a water supplier is pivoted in the water passage of the blade socket and includes a through hole communicating with the water passage.

6. The wastewater separator as claimed in claim 1, wherein the power source consists of a first motor and a second motor, a first active member is fixed on a shaft of the first motor and connected to the inner pivoting assembly, and a second active member is fixed on a shaft of the second motor and connected to the outer pivoting assembly.

7. The wastewater separator as claimed in claim 1, wherein the power source consists of a motor, a third active member and a fourth active member are fixed on a shaft of the motor of the power source, the third active member is connected to the inner pivoting assembly through a second drive member, the fourth active member is connected to the outer pivoting assembly though a first drive member.

8. The wastewater separator as claimed in claim 1, wherein the power source consists of a motor and a gear box, the motor of the power source is connected to a gear cluster in the gear box, and a first gear and a second gear are exposed out of the gear box, the first gear is engaged with the outer pivoting assembly, and the second gear is engaged with the inner pivoting assembly.

9. A wastewater separator comprising:
a housing being provided with a power source;
an outer pivoting assembly being pivoted to the housing and connected to the power source, the outer pivoting assembly being driven to pivot about an axis vertical to a ground by the power source, the outer pivoting assembly including a cover cylinder; and
an inner pivoting assembly being pivoted in the outer pivoting assembly and connected to the power source, the inner pivoting assembly being driven to pivot about an axis vertical to the ground by the power source, the inner pivoting assembly including a blade which helically extends in an axial direction of the pivoting assembly and is arranged opposite to the cover cylinder, the outer pivoting assembly and the inner pivoting assembly pivoting in the same direction, the outer pivoting assembly and the inner pivoting assembly and being both driven by the power source to pivot for enabling an impurity which is relatively heavy in the wastewater to fall down along the blade and a water which is relatively light in the wastewater to flow upwards along the cover cylinder, so as to separate the impurities from the water in the wastewater.

10. The wastewater separator as claimed in claim 9, wherein the outer pivoting assembly further includes a sleeve, a connecting case and a cover cylinder that are integrally connected to one another, the sleeve is exteriorly provided with a first passive member connected to the power source, the connecting case is axially formed with a through hole from which the water flows out.

11. The wastewater separator as claimed in claim 10, wherein the cover cylinder of the outer pivoting assembly is vertically tapered downwards or in the form of a straight member.

12. The wastewater separator as claimed in claim 9, wherein the inner pivoting assembly further includes a duct, a blade socket and a blade, the duct includes a guiding hole and is exteriorly provided with a second passive member connected to the power source, the blade socket is radially formed at an upper end thereof with plural flow passages communicating with one another, an upper end of the blade socket is integrally connected with the duct, the flow passages of the blade socket communicate with the guiding hole of the duct, the blade is disposed on a side surface of the blade socket.

13. The wastewater separator as claimed in claim 12, wherein the blade socket of the inner pivoting assembly includes a water passage and plural water outlet passages, the water passage is axially formed under the blade socket, one end of the respective water outlet passages communicates with the water passage, and the other end of the respective water outlet passages communicates outwards from the side surface of the blade socket, a water supplier is pivoted in the water passage of the blade socket and includes a through hole communicating with the water passage.

14. The wastewater separator as claimed in claim 9, wherein the power source consists of a first motor and a second motor, a first active member is fixed on a shaft of the first motor and connected to the inner pivoting assembly, and a second active member is fixed on a shaft of the second motor and connected to the outer pivoting assembly.

15. A wastewater separator comprising:
a housing being provided with a power source;
an outer pivoting assembly being pivoted to the housing and connected to the power source, the outer pivoting assembly being driven to pivot about an axis vertical to a ground by the power source, the outer pivoting assembly including a cover cylinder; and
an inner pivoting assembly being pivoted in the outer pivoting assembly and connected to the power source, the inner pivoting assembly being driven to pivot about an axis vertical to the ground by the power source, the inner pivoting assembly including a blade which helically extends in an axial direction of the pivoting assembly and is arranged opposite to the cover cylinder, the outer pivoting assembly and the inner pivoting assembly pivoting in the same direction, a pivoting speed of the inner pivoting assembly being greater than that of the outer pivoting assembly, the outer pivoting assembly and the inner pivoting assembly and being both driven by the power source to pivot for enabling an impurity which is relatively heavy in the wastewater to fall down along the blade and a water which is relatively light in the wastewater to flow upwards along the cover cylinder, so as to separate the impurities from the water in the wastewater.

16. The wastewater separator as claimed in claim 15, wherein the outer pivoting assembly further includes a sleeve, a connecting case and a cover cylinder that are integrally connected to one another, the sleeve is exteriorly provided with a first passive member connected to the power source, the connecting case is axially formed with a through hole from which the water flows out.

17. The wastewater separator as claimed in claim 16, wherein the cover cylinder of the outer pivoting assembly is vertically tapered downwards or in the form of a straight member.

18. The wastewater separator as claimed in claim 15, wherein the inner pivoting assembly further includes a duct, a blade socket and a blade, the duct includes a guiding hole and is exteriorly provided with a second passive member connected to the power source, the blade socket is radially formed at an upper end thereof with plural flow passages communicating with one another, an upper end of the blade socket is integrally connected with the duct, the flow passages of the blade socket communicate with the guiding hole of the duct, the blade is disposed on a side surface of the blade socket.

19. The wastewater separator as claimed in claim 18, wherein the blade socket of the inner pivoting assembly includes a water passage and plural water outlet passages, the water passage is axially formed under the blade socket, one end of the respective water outlet passages communicates with the water passage, and the other end of the respective water outlet passages communicates outwards from the side surface of the blade socket, a water supplier is pivoted in the water passage of the blade socket and includes a through hole communicating with the water passage.

20. The wastewater separator as claimed in claim 15, wherein the power source consists of a first motor and a second motor, a first active member is fixed on a shaft of the first motor and connected to the inner pivoting assembly, and a second active member is fixed on a shaft of the second motor and connected to the outer pivoting assembly.
